(19) United States
(12) Patent Application Publication
(10) Pub. No.: US 2010/0186007 A1
(43) Pub. Date: Jul. 22, 2010

(54) IMAGE DISPLAY APPARATUS AND METHOD FOR CONTROLLING THE SAME

(76) Inventor: Se-Ho Jeong, Gyeonggi-do (KR)

Correspondence Address: KED & ASSOCIATES, LLP, P.O. Box 221200, Chantilly, VA, 20153-1200, US

(21) Appl. No.: 12/663,382

(22) PCT Filed: Jun. 12, 2008
(86) PCT No.: PCT/KR08/03273

§ 371 Date: Dec. 7, 2009

(30) Foreign Application Priority Data
Jun. 12, 2007 (KR) 10-2007-0057060

(51) Int. Cl. G06F 9/44

(52) U.S. Cl. 717/170; 717/173

(57) ABSTRACT

Provided is an image display device. The image display device includes a firmware interface, a storage, and a controller. The firmware interface downloads a firmware from an outside. The storage stores information of the firmware downloaded through the firmware interface. The controller generates download history information using information of the firmware stored in the storage, and controls the download history information to be displayed on a display unit upon request by a user.

### TECHNICAL FIELD

The present disclosure relates to a version management system of a firmware and a method thereof, and more particularly, to a method for updating a firmware in an image display device.

### BACKGROUND ART

In general, a microprocessor of an image display device performs a predetermined function using a program and information stored in a read only memory (ROM), and the program and information stored in the ROM are modified through ROM collection.

A related art ROM collection method is schematically described. A user records information to be modified on an electrically erasable programmable read only memory (EEPROM) through a ROM writer jig and a program for ROM write and then turns off power and turns on power. Therefore, a product should be decomposed and the EEPROM should be replaced in order to record new information. Also, when the power is turned on, the microprocessor reads the information recorded on the EEPROM and stores the read information in a random access memory (RAM) called a ROM collection register. After storing the information to be modified in the ROM collection register, the microprocessor reads and uses the information recorded in the ROM collection register when information of the information modification-requested ROM is required.

As described above, since the ROM writer and the program for ROM write are indispensably required and a product should be decomposed to replace the EEPROM in a related art, a modification process has been inconvenient.

Meanwhile, in the past, electronic products were mostly single products providing a simple function. For example, a digital versatile disc (DVD) performed only a DVD reproduction function, and a video cassette recorder (VCR) performed only a VCR reproduction function. Products combining these products were not available.

However, recently, composite products such as a DVD/VCR combo and an ID-VCR, combining other image devices in one product are brought to the market. Moving picture experts group (MPEG) technology to which a firmware is applied is mounted inside these composite products.

The above-described firmware is a kind of a program stored in a recording medium such as a ROM in order to increase the efficiency of a system. Since the firmware is included in a hardware at the time of manufacturing so that it is hard to erase or modify, it is called firmware, not a program and not a device. The firmware is installed inside a hardware and contains information indispensable to a device operation and a program required for performing a basic operation.

Since the composite product is controlled by a firmware, the firmware should be upgraded often when an upgrade such as performance improvement and bug patch is required.

### DISCLOSURE OF INVENTION

### Technical Problem

In a related art, a program is stored in a compact disc (CD)-ROM, and then data are read to upgrade a firmware. Also, in an image display device currently under development and brought to the market, firmware information is displayed on a service menu. However, in most cases, since only firmware version information is displayed, when a trouble is generated during a manufacturing process or in the field, a reason of the trouble cannot be analyzed accurately and thus an immediate measure cannot be taken.

That is, a developer or a manufacturer of an image display device or a firmware needs to make clear who is responsible for a firmware when a trouble is generated to the firmware. In this case, it has been impossible to judge whether a trouble has been generated while the firmware is updated or the software itself is troublesome.

Also, even when the trouble has been generated while the firmware is updated, it is even more difficult to know a path through which the firmware has been provided.

### Technical Solution

Embodiments provide an image display device for managing a firmware download history and an update history, and a control method thereof.

Embodiments also provide an image display device that can guide a user so that the user can easily update a firmware, and a control method thereof.

In one embodiment, an image display device includes: a firmware interface downloading a firmware from an outside; a storage storing information of the firmware downloaded by the firmware interface; and a controller generating download history information using information of the firmware stored in the storage and controlling the download history information to be displayed on a display unit upon request by a user.

In another embodiment, a method for controlling an image display device includes: receiving a firmware from an outside; judging whether the received firmware is a new version firmware using version information of the received firmware; when the received firmware is the new version firmware as a result of the judgment, backing-up an old version firmware stored in a memory; downloading the new version firmware; and recording download history information of the old version firmware and the new version firmware.

The details of one or more embodiments are set forth in the accompanying drawings and the description below. Other features will be apparent from the description and drawings, and from the claims.

### Advantageous Effects

An embodiment can provide a user with a method for updating a firmware to a new version firmware. The user can update various firmwares of a system or an image display device having the system using a simple method.

Also, when an error is generated while a firmware is updated, a user (a manager or a manufacturer) of the image display device can check in which path a trouble has been generated.

### BRIEF DESCRIPTION OF THE DRAWINGS

FIG. 1 is a block diagram of a firmware management system of an image display device according to an embodiment.

FIG. 2 is a view illustrating a service menu displayed to a user by an image display device according to an embodiment.

FIG. 3 is a view illustrating firmware download history information according to an embodiment.

FIG. 4 is a view illustrating firmware download history information according to an embodiment.

FIGS. 5 to 7 are views explaining an operation of guiding a firmware update in a method for controlling an image display device according to an embodiment.

FIGS. 8 and 9 are flowcharts explaining a firmware version management method in a method for controlling an image display device according to an embodiment.

### MODE FOR THE INVENTION

Reference will now be made in detail to the embodiments of the present disclosure, examples of which are illustrated in the accompanying drawings.

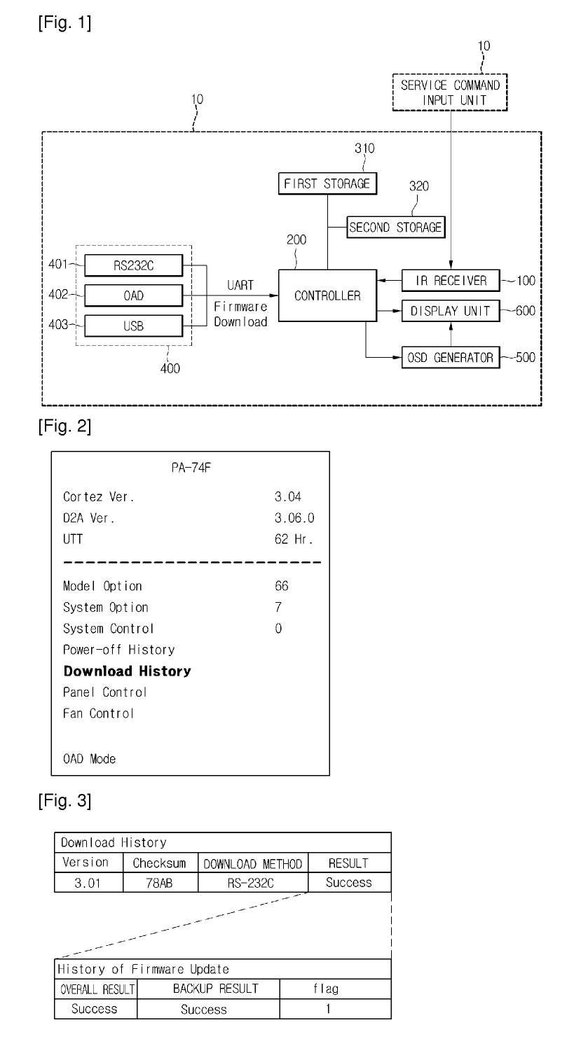

FIG. 1 is a block diagram of a firmware management system of an image display device according to an embodiment.

The firmware version management system can be applied to other electronic apparatus as well as an image display device such as a digital television (DTV). A user of the firmware version management system can be a manager of the system or a manufacturer.

Referring to FIG. 1, the firmware version management system of the image display device includes an infrared (IR) receiver 100 receiving a service command from a service command input unit 10, a firmware interface 400 allowing a firmware provided from an outside to be provided to a controller 200, a first storage 310 storing the firmware downloaded from the firmware interface 400, a second storage 320 backing-up an old version firmware, and the controller 200 controlling download history information of the firmware to be displayed.

Also, the firmware version management system includes a display unit 600 displaying the firmware download history information in response to a control signal from the controller 200, and an on-screen-display (OSD) generator 500 generating the firmware download history information in the form of an OSD in response to a control signal of the controller 200.

The controller 200 can include a micro-controller in which at least one program is installed, and allows a new version firmware downloaded through the firmware interface 400 to be stored in the first storage 310.

Here, an old version firmware already stored in the first storage 310 is backed-up by the second storage 320.

Consequently, while a new version firmware is downloaded, an old version firmware already stored is backed-up in the second storage 320 such as a temporary memory, so that the controller 200 determines whether to delete the old version firmware that has been backed-up depending on whether update to the new version firmware is completely performed.

The update of the firmware may not be completely performed due to other external environment changes during the updating operation. In this case, a program of the controller may not normally operate.

The controller 200 performs the updating operation using the new version firmware newly stored in the first storage 310, and manages history information of having downloading the firmware.

Particularly, the controller 200 manages history information of each firmware downloaded, and displays a firm version, a checksum value, a download method, and a download result upon request by a user.

The controller 200 also manages information of a path through which a firmware has been downloaded as history information of the downloaded firmware to allow the user to know whether a download operation of the firmware has not been normally performed or whether a trouble has been generated during the download operation in the case where the firmware update has not been normally performed.

The firmware interface 400 is a device for receiving a firmware provided from the outside. A computer can download a firmware through RS-232C 401, which is one of internationally standardized data communication standard, to give and take material to and from the outside.

Also, the firmware can be downloaded even through an on-air-download (OAD) 402 or a universal serial bus (USB) 403. The system is provided inside the image display device including a tuner and a USB recognizer, various download methods can be used.

A case of downloading the firmware through the OAD is briefly described. A firmware provider encodes a new version firmware applied to a digital broadcasting receiver using an object carousel protocol (OC), and provides the same.

A stream in which the provided OAD firmware has been encoded using the OC is multiplexed with an A/W stream of a broadcasting station and a data stream for data broadcasting and a program index.

A digital broadcasting receiver such as a DTV operates an OAD service module, extracts a firmware included in a broadcasting signal to detect a current version of a firmware built in a current digital broadcasting receiver, detects the version of a firmware included in a transport stream being transmitted, compares the version of the detected firmware included in the transport stream with that of a software of the current digital broadcasting receiver, detects the manufacturer and the model name of the digital broadcasting receiver and detects modules supported by the detected model and version information of the module when the current firmware has an old version.

As described above, when OAD service exists in a received transport stream, the OAD service is registered in an OAD engine and OAD data is filtered from the transport stream and downloaded, so that firmware update is performed.

The above-described firmware interface 400 can be realized by various technical construction. The controller 200 stores/manages paths through which firmwares are downloaded.

That is, the controller 200 manages information as to whether the download paths of firmwares stored in the first storage 310 have been downloaded through RS-232C 401 or the OAD service.

Also, the controller 200 stores/manages a firmware version, a checksum value, and a download result besides the download method as the download history information of the firmware, and displays the history information upon request by a user.

Further, the controller 200 compares a firmware received through the firmware interface 400 with a firmware stored in the first storage 310 to judge whether the firmware received through the firmware interface 400 has a new version. When the firmware already stored in the first storage 310 has an old version as a result of the judgment, the controller 200 backs-up the old version firmware in the second storage 320 and asks a user whether to perform an update to a new version firmware.

The operation of the firmware version management system is described below.

When a service command is input through the service command input unit 10, the IR receiver 100 receives this service command and delivers the service command to the controller 200. The controller 200 outputs a control signal to the OSD generator 500 to display a corresponding service menu on the display unit 600.

Then, a desired menu is selected with reference to the service menu displayed by the display unit 600. At this point, the displayed service menu includes model option, system option, system control, power-off history, download history, panel control, and fan control as illustrated in FIG. 2.

FIG. 3 is a view illustrating firmware download history information according to an embodiment.

When the download history is selected, download history is displayed as illustrated in FIG. 3. At this point, displayed information includes a firmware version, a checksum value, a download method, and a download result.

For example, referring to FIG. 3, a firmware version 3.01 has a history that the firmware has been downloaded through RS-232C with s checksum 78AB and update of the firmware version 3.01 has been successful.

Here, in the case where a user moves a cursor to request detailed information as to whether the update has been successful, the controller 200 shows the detailed information regarding update performance result of the firmware, that is, shows a backup performance result of an old version firmware and a flag value (as a sign) thereof.

That is, a firmware update to a new version has been successful, a backup result for the old version firmware has been successful, and flag=1 shows download of a new version firmware has been also successful.

Backup result shows whether a process of backing-up an old version firmware stored in the first storage 310 in the second storage 320 has been successful, and sign shows whether a process of downloading a new version firmware in the first storage 310 has been successful, wherein the sign is a flag value indicating 0 or 1.

In the embodiment, flag=1 shows a new version firmware has been successfully downloaded in the first storage 310, and flag=0 shows a new version firmware has not been successfully downloaded in the first storage 310.

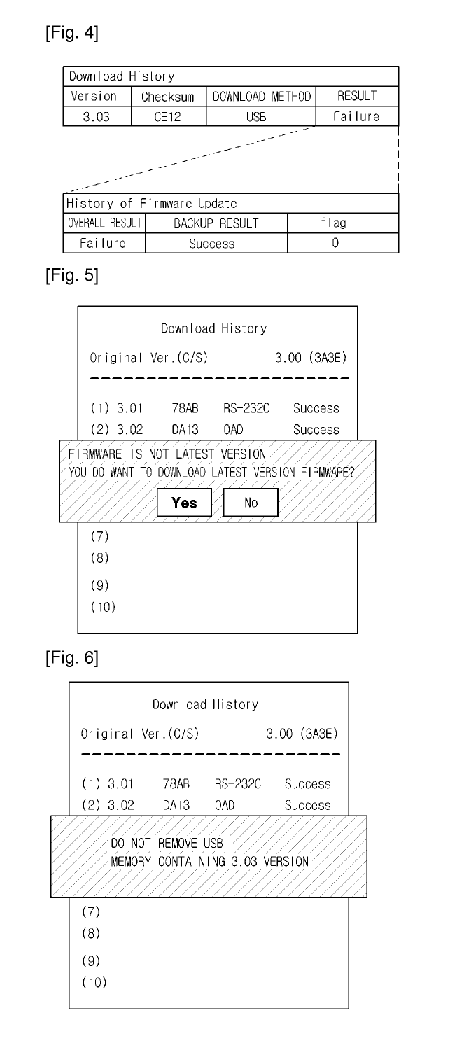

Since the firmware cannot be updated to a new version firmware when the new version firmware has not been successfully downloaded in the first storage, a program is operated by the old version firmware backed-up in the second storage 320, which will be described with reference to FIG. 4.

FIG. 4 is a view illustrating firmware download history information according to an embodiment.

FIG. 4 illustrates a history that a firmware version 3.03 has a checksum CE12 and a downloading operation through an USB memory has been tried. A download result is shown as failure.

Detailed information as to whether firmware update has been successful can be shown upon request by a user. Overall result is failure, a backup result is success, and a flag value is 0 in a case of FIG. 4.

This case shows that a process of backing-up an old version firmware stored in the first storage 310 in the second storage 320 to download a new version firmware has been successful, but a trouble has been generated to a process of downloading a new version firmware in the first storage 310 because a flag value is 0, which means the new version firmware has not been successfully downloaded. Therefore, since the firmware has not been updated to the new version, the controller 200 drives a program using the old version firmware stored in the second storage 320.

Also, since a download operation of the new version firmware has not been successfully performed, the user of the system can identify a trouble has been generated to a download process through a USB memory.

Meanwhile, the system of an embodiment guides a user so that the user updates a firmware, which will be described with reference to FIGS. 5 to 7.

FIGS. 5 to 7 are views explaining an operation of guiding a firmware update in a method for controlling an image display device according to an embodiment.

Referring to FIG. 5, the controller 200 compares the version information of a firmware provided through the firmware interface 400 with the version information of a firmware stored in the first storage 310 or the second storage 320.

When the firmware stored in the first storage 310 or the second storage 320 is judged to be an old version as a result of the comparison, the controller 200 displays a message OSD as to whether to perform an update to a new version through the display unit.

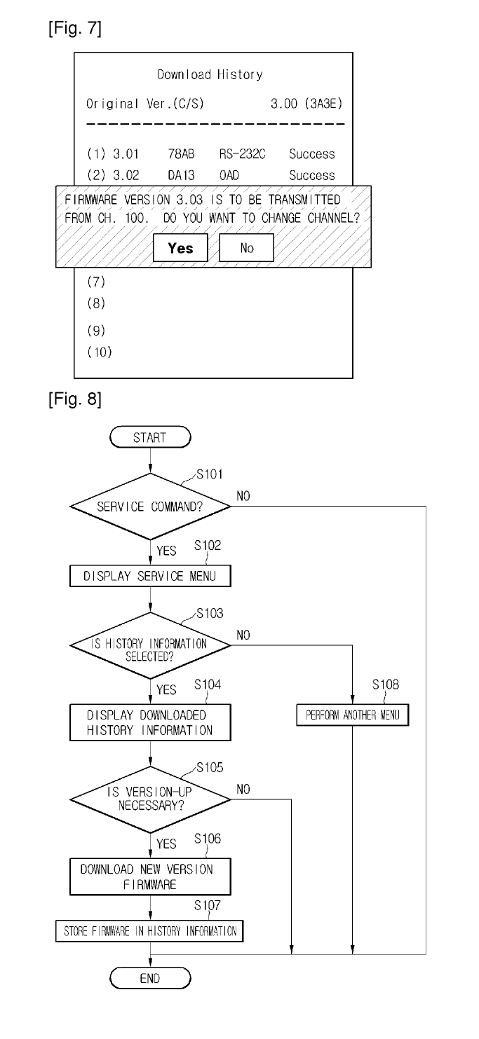

Also, when a request for a firmware update is input by a user, the controller 200 can further display a guidance message as illustrated in FIGS. 6 and 7.

That is, as illustrated in FIG. 6, the controller 200 displays a message requesting the user not to remove a USB memory connected to the firmware interface 400, and performs a download operation of a firmware stored in the USB memory.

Meanwhile, in the case where download history information shows that backup of an old version firmware has been successful but download of a new version firmware has not been successful, the controller 200 can display a guidance message that “Insert a USB memory containing version 3.03”.

In the case where the user views history information to select a specific firmware, a new version of the selected firmware may not be downloaded successfully.

That is, according to download history information, the downloading of the firmware version 3.03 have been tried but a trouble has been generated during the downloading operation. In this case, the controller 200 can guide the user so that the user inserts the USB memory containing the relevant version firmware to retry the download.

Also, FIG. 7 illustrates OAD service is used. In this case, a message that “Firmware version 3.03 is to be transmitted from a channel 100. Do you want to change channel?” is displayed and firmware download is performed through channel change by a user or automatic channel change.

Through these processes, the system can guide the user so that the user updates the firmware to a new version, and thus the user can update the system or various firmwares of an image display device having the system using a simple method.

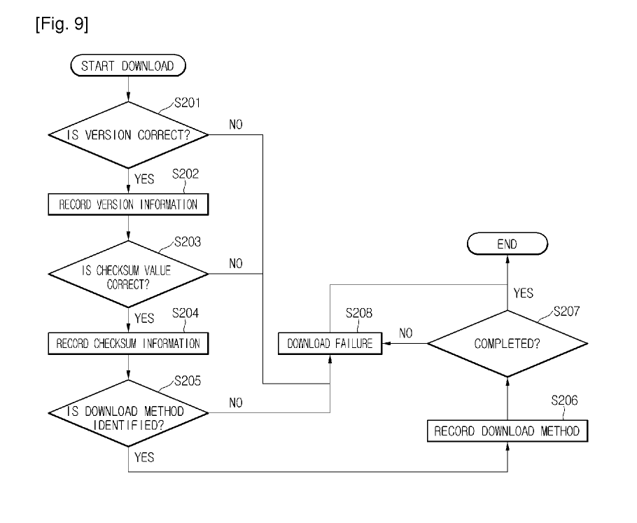

A firmware version management method in the system of the present disclosure is described with reference to FIGS. 8 and 9.

FIGS. 8 and 9 are flowcharts explaining a firmware version management method in a method for controlling an image display device according to an embodiment.

When a service command is input, a service menu is displayed (S101-S102).

Whether download history information is selected by a user is judged (S103).

When the download history information is selected as a result of the judgment (S103), downloaded history information is displayed (S104).

Whether version-up is necessary is judged (S105).

When the version-up is necessary as a result of the judgment (S105), a new version firmware is downloaded and additionally stored in the history information (S106-S107). Here, the new version firmware is downloaded after an old version firmware is backed-up. This is for allowing a program to be normally operated using the old version firmware in the case where the new version firmware has not been successfully downloaded.

When the download history information is not selected by the user as a result of the judgment (S103), another menu is performed (S108).

Also, a method for downloading a firmware is described with reference to FIG. 9. When download starts, whether version is correct is judged (S201).

Subsequently, when the version is correct as a result of the judgment (S201), version information is recorded (S202).

Whether a checksum value is correct is judged and then the checksum value is recorded (S203-S204).

Also, when a download method is identified, the download method is recorded (S205-S206).

When all are completed, an operation is ended. When the identification is not accurately made in the above operation, download failure is judged and the operation is ended (S207-S208).

The system and the method according to an embodiment perform a firmware download to store firmware download history, and displays relevant firmware download history information on a service menu to allow a user to know download history.

### INDUSTRIAL APPLICABILITY

The system and the method according to an embodiment allows a firmware update to be automatically performed and allows a user (manager or manufacturer) to easily know firmware download history information conveniently. Since the system can be applied to an image display device, it has industrial applicability.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An image display device comprising:
a firmware interface downloading a firmware from an outside;
a storage storing information of the firmware downloaded through the firmware interface; and
a controller generating download history information using information of the firmware stored in the storage and controlling the download history information to be displayed on a display unit upon request by a user.

2. The image display device according to claim 1, wherein the downloaded firmware information comprises at least one of a version number or a checksum.

3. The image display device according to claim 1, wherein the download history information comprises information for a path through which the firmware has been downloaded.

4. The image display device according to claim 1, wherein the download history information comprises information for a backup result of an old version firmware already stored in the storage.

5. The image display device according to claim 1, wherein the download history information comprises a sign representing whether download of a firmware to be downloaded has been successful.

6. The image display device according to claim 1, wherein the storage comprises a second storage storing a new version firmware provided through the firmware interface and a first storage backing-up an old version firmware and.

7. The image display device according to claim 1, wherein when a user selects a specific firmware from the download information, the controller guides the user so that the user downloads a new version of the selected firmware.

8. The image display device according to claim 1, wherein the storage accumulates download history information of firmwares.

9. A method for controlling an image display device, the method comprising:
receiving a firmware from an outside;
judging whether the received firmware is a new version firmware using version information of the received firmware;
downloading the new version firmware; and
recording download history information of the new version firmware.

10. The method according to claim 9, further comprising, when the received firmware is the new version firmware as a result of the judgment:
backing-up an old version firmware stored in a memory; and recording download history information of the old version firmware.

11. The method according to claim 10, wherein the recording of the download history information comprises recording at least one of firmware versions or checksums of the old version firmware and the new version firmware.

12. The method according to claim 9, wherein the recording of the download history information comprises recording information about download paths of the firmwares.

13. The method according to claim 10, wherein the recording of the download history information comprises recording information about results of backing-up the old version firmware.

14. The method according to claim 10, wherein the recording of the download history information comprises recording methods of downloading the old version firmware and the new version firmware, and information as to whether the downloads have been successful.

15. The method according to claim 9, further comprising, after the recording of the download history information:
when a download history information reading request is received from a user, displaying the recorded download history information; and
guiding update of a firmware using the displayed history information.
